(19) United States
(12) Patent Application Publication
(10) Pub. No.: US 2008/0035563 A1
(43) Pub. Date: Feb. 14, 2008

(54) Immersed-Membrane Water Treating Filtering Device Comprising Means Preventing Filterable Medium Backflowing to Filter Cleaning Gas Injecting Means

(75) Inventors: Michel Badard, Clamart (FR); Laurence Dumoulin, Paris (FR); Christian Goudal, Eaubonne (FR)

Correspondence Address: COATS & BENNETT, PLLC, 1400 Crescent Green, Suite 300, Cary, NC, 27518, US

(73) Assignee: OTV SA, Saint-Maurice Cedex (FR)

(21) Appl. No.: 11/568,486

(22) PCT Filed: Apr. 27, 2005
(86) PCT No.: PCT/FR05/01051

§ 371 Date: Oct. 30, 2006

(30) Foreign Application Priority Data
Apr. 29, 2004 (FR) 0404552

(51) Int. Cl. B01D 61/18; B01D 63/02; B01D 65/02; B01D 65/08; B01F 3/04; C02F 1/44; C02F 3/12

(52) U.S. Cl. 210/636; 210/106

(57) ABSTRACT

A water treating system is provided with a membrane chamber having one or more membranes disposed therein for filtering water. To periodically clean the membranes, there is provided a series of cleaning fluid inlets that permit a cleaning fluid, such as a gas, to be injected through the inlets into the membrane chamber which results in the cleaning fluid cleaning the membranes therein. The cleaning fluid inlets are normally closed and are adapted to open in response to the pressure of the cleaning fluid reaching a certain pressure level.

The invention relates to the water treatment field. More precisely, the invention relates to a device for injecting a filter cleaning gas into a bundle of filtering membranes immersed in a filterable medium.

According to a known filtering technique, the filtering system comprises vertical immersed membranes grouped into a module generally cylindrical or parallelepiped in shape. Traditionally, these modules incorporate flat plates or hollow fibres of organic membranes, potted at least at their lower end.

The treated liquid is filtered under the effect of a pressure difference maintained between the two sides, upstream and downstream, of the membranes.

These membranes are traditionally micro-filtration, ultra-filtration or nano-filtration membranes.

The invention applies particularly to devices in which the membranes are arranged in the vertical position, but also applies to filtering devices in which the membranes are immersed in the horizontal position.

These immersed-membrane systems are used particularly for treating water that is to be made drinkable, with a view to keeping the pollution in suspension in the water or else to prevent microscopic animalcules (protozoa), such as cryptosporidium or giardia, bacteria and/or viruses from passing through, or again to keep back powdery reagents or catalysts, such as activated charcoal dust or alumina, which have been injected into the treatment system upstream of the membranes.

This type of membrane is also used in immersion in membrane bio-reactors (often known as “MBR”) as a means of clarifying waste water treated by a biomass in suspension in the reactor, and as a means of preserving the biomass inside the reactor.

Membrane modules are often clustered into racks or cartridges, with a support and common connections for all the modules in the rack or cartridge.

In known immersed-membrane filtering systems, one problem lies in the gradual fouling of the membranes by the filterable materials, known as sludge, and this is particularly the case with regard to membranes that are immersed in a bioreactor containing activated sludge.

Indeed, the membranes gradually become fouled with sludge trapped on their surface and in the substance thereof, or even, in the case of severe fouling of the fibre bundle, by plugs of sludge and/or fibrous material trapped by said bundle.

This fouling requires action to be taken to clean the filter, often using periods of retro-filtering through the permeate, with or without chemical reagent, or again by chemically washing the membranes.

More often than not, in order to clean the membranes and/or delay the fouling thereof, a gas (generally air) is injected, continuously or cyclically, into the inner part of the membrane module.

The bubbles of gas injected rise along the fibre or the plate with a speed which tends to restrict the deposit of material on the membrane, thereby reducing the rate at which the filtering membranes become fouled.

This is due to the fact that the rise of the injected gas bubbles creates strong turbulence, more or less agitating the neighbouring fibres, mechanically cleaning the fibres or flat plates by the action of the injected air, which in the end delays the fouling of the membrane bundle.

Various processes have been proposed for injecting a filter cleaning gas of this kind.

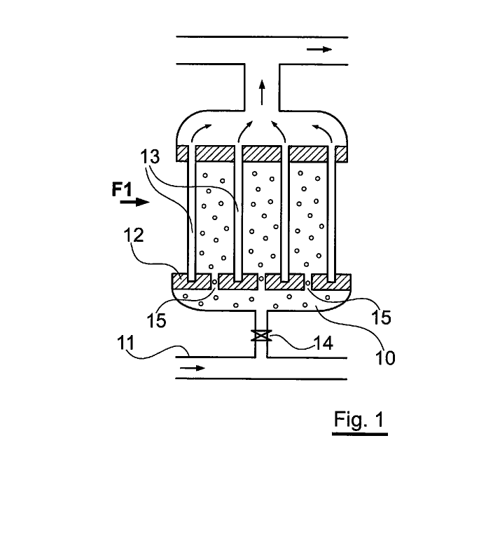

According to a known technique shown in FIG. 1, the gas is injected directly into a enclosed chamber 10 (using a pipe 11) located under the lower potting 12 of the hollow fibre bundles 13, the air being distributed between modules using a gate 14 or a calibrated orifice, prior to passing into the apertures 15 provided in the lower potting of the fibre bundles.

According to this technique, the filterable medium passes through the membranes in the direction indicated by the arrow Fl.

The use of this system leads to the injection apertures becoming fouled very quickly. Indeed each time the gas injection is stopped, a part of the treatable medium penetrates into these apertures, and the sludge thus brought in is dried by the gas when injection resumes, which rapidly causes the apertures to become fouled if not completely blocked.

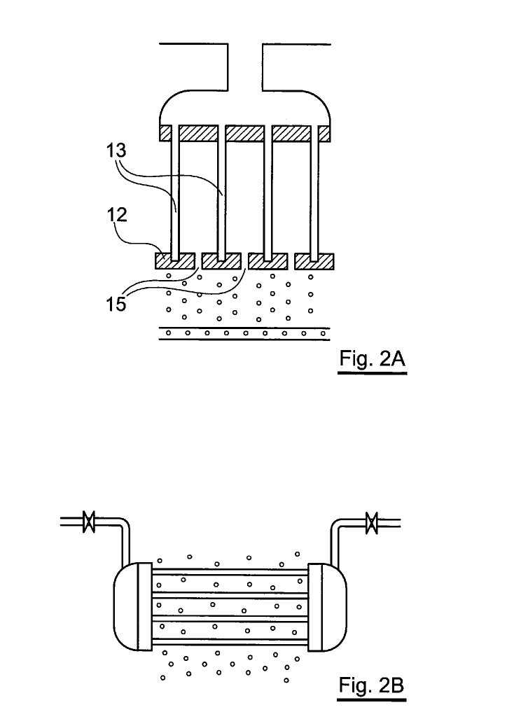

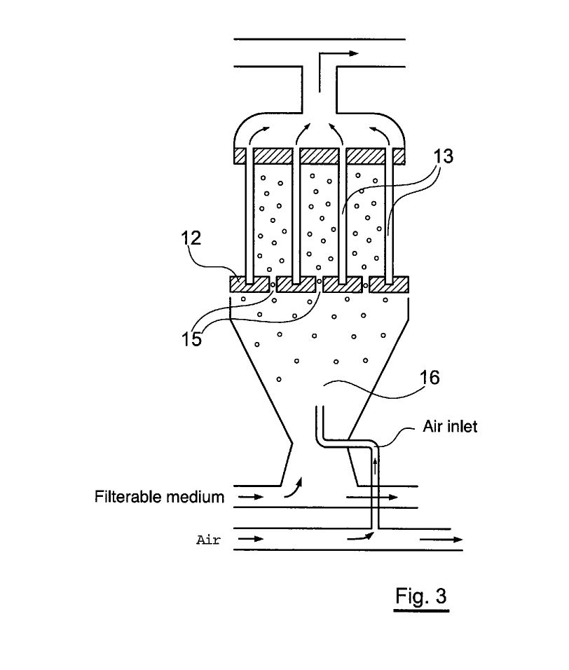

FIGS. 2a and 3 each show another technique according to which the filterable medium and the filter cleaning gas are both injected through apertures 15 provided in the lower potting 12 of the hollow fibre bundles 13.

This system has the theoretical advantage of preventing the sludge deposited in the apertures from drying under the effect of the gas passing through.

According to the device shown in diagrammatic form in FIG. 2a, the hollow fibre bundle 13 is immersed vertically into the filterable medium, (for example activated sludge in an MBR) and filter cleaning air is brought under each module through piping fitted with perforations allowing air to pass.

The air injected under the modules enters the modules, then rises inside the modules along the hollow fibres, before escaping through the sides or through similar orifices provided in the upper potting of the modules.

According to the device shown in diagrammatic form in FIG. 2b, the filter cleaning air is also brought under each module through piping fitted with perforations allowing air to pass, the membrane module being shown here in the horizontal position.

According to the device shown in diagrammatic form in FIG. 3, a venturi type system is provided to distribute the sludge flow and gas flow equally under the modules.

One drawback of the gas injection method employed in these techniques is that the air injection apertures located in the base of the membrane bundle gradually become fouled on account of the depositing of sludge (or large particles, fibres etc brought in by the treatable liquid), as well as in the sludge/air mix area 16.

Consequently, this phenomenon gradually causes poor distribution of gas, which is unevenly distributed at the base of each module or between the different modules, and finally an accelerated fouling of the parts of the fibre bundle or flat plates inadequately swept by the filter cleaning gas.

Another objective of the invention is to overcome the drawbacks of the prior art.

To be more exact, the objective of the invention is to propose a filtering device for use in water treatment, of the type with membranes immersed in a filterable medium and comprising means for injecting a membrane cleaning gas, which eliminates the fouling effects of injection means encountered with prior art solutions.

Another objective of the invention is to provide a filtering device of this kind which allows a good distribution of filter cleaning gas in the membrane bundles.

Another objective of the invention is to provide a filtering device of this kind which is compatible with different systems for injecting filter cleaning gases.

Another objective of the invention is to provide a filtering device of this kind which limits maintenance interventions or which facilitates them when they are necessary.

Another objective of the invention is to provide a filtering device of this kind which is simple to design and easy to implement.

Yet another objective of the invention is to provide a filtering device of this kind which is not aggressive for the membranes.

These objectives, as well as others which will emerge subsequently, are attained through using invention, the subject matter of which is a filtering device using at least one membrane, intended to be fitted in a water treatment plant, of the type immersed in a filterable medium and comprising means for injecting a gaseous fluid in the form of bubbles intended to clean said membrane or membranes, characterised in that it comprises backflow prevention means preventing said filterable medium from coming into contact with said injecting means.

In this way, the fouling effects occurring directly in the injection system itself are eliminated, or at the very least restricted, such effects being common with prior art solutions.

With fouling of the injection means prevented, the filter cleaning gas can then be dispensed with satisfactory and near constant distribution.

It will therefore be understood that maintenance interventions to clean the gas injecting means can, through the invention, be substantially reduced, or even eliminated.

The backflow prevention means according to the invention may act directly on the gas injecting means or in the injection apertures in the filtering module, as will be seen more clearly below.

Furthermore, a curtain of bubbles is obtained which has a protective function over the membranes and prevents them being attacked by the filterable materials.

According to a first approach of the invention, said injecting means comprise at least one orifice provided in at least one inlet nozzle of said gaseous fluid, said backflow prevention means including at least one material for covering said orifice or orifices, having at least one resiliently distortable passage the outlines of which move apart when the pressure of said gaseous fluid exceeds a preset pressure in said inflow tube and come together when the pressure of said gaseous fluids is less than said preset pressure.

In this way, the backflow prevention means allow the filter cleaning gas to pass during an injection phase, while they close up again on themselves whenever the injection stops.

Therefore, whenever gas injection stops, the injection orifices are protected from contact with the filterable medium and from contact with any sludge that this medium contains.

Sludge being deposited, or even drying on the injection orifices, as noted with solutions of the prior art, is therefore avoided.

According to a first embodiment of this approach, said inlet nozzle or nozzles extend substantially horizontally under said membranes.

The invention can therefore be adapted to devices in which the injectable gas is brought under the filtering modules using perforated piping, as described previously with reference to FIGS. 2a and 2b.

In this case, said covering material preferentially forms an added watertight sleeve on each of said nozzles.

Such a sleeve proves indeed to be particularly adapted to the shape of the piping and allows easy and rapid installation and anchoring.

According to a first conceivable alternative, said membrane or membranes extend substantially horizontally.

According to a second conceivable alternative, said membrane or membranes extend substantially vertically, said injecting means comprising at least one aperture provided in the vicinity of at least one of the ends of said membranes.

According to a first embodiment of this second alternative, said nozzle or nozzles extend at least partially through said aperture or apertures.

Such an embodiment therefore appears particularly adapted to filtering devices in which the filtering modules are served by a sealed filter cleaning gas distribution enclosure.

It can be understood therefore that, since the nozzles fitted with their covering material extend through the injection apertures, the apertures come to be protected against fouling, and are so because of the nozzles themselves and their covering material.

Preferentially, said covering material forms a cap carried by said nozzle or nozzles.

In this way backflow prevention means are obtained that are straightforward to design and easy to implement.

According to a first embodiment variant of the nozzle or nozzles, they have an end flush in said space relative to said aperture or apertures, said orifice or orifices being provided on said flush end.

In this case, said cap or caps have a length that is substantially longer than that of said nozzle or nozzles.

It is therefore possible to vary the length of the cap as a function particularly of the required pressure loss.

According to a second variant of the nozzle or nozzles, they have a cylindrical portion extending into a space in the vicinity of said membrane or membranes.

In this case, said orifice or orifices are to advantage provided on the periphery of said cylindrical portion.

In this way, the gas bubbles are injected radially, in the direction of the membrane walls which tends to further improve the cleaning thereof.

According to a preferred solution of this embodiment variant, said cylindrical portion or portions have a length of between about 20 mm and about 500 mm, and preferentially have a length of about 60 mm.

These dimensions are particularly adapted to secure an effective cleaning of membranes with a height of about 1000 to 2000 mm, or even 2500 mm.

According to another characteristic of this embodiment variant, said cap has a length substantially equal to that of said cylindrical portion.

According to a preferred solution of this second embodiment, said cap or caps have a length of between about 20 mm and about 200 mm, and preferentially have a length of about 60 mm.

To advantage, said cap or caps have at least one substantially vertical slit, forming said resiliently distortable passage, and preferentially have, at their periphery, a plurality of evenly distributed slits.

In this way a good distribution of bubbles is obtained in the spaces provided between the membranes, the bubbles being directed towards the walls of these membranes on account of the radial distribution of the slits.

According to a third variant of the nozzle or nozzles, they have a dome-shaped end extending in said space or spaces provided between said membranes, said orifice or orifices being provided on said dome.

In this case, said nozzle or nozzles preferentially have two orifices, said cap or caps having a slit extending radially between said two orifices.

To advantage, said slit extends over a length of between about the diameter of the base of said dome and about a third of said diameter.

It is possible in this way to obtain a satisfactory pressure loss, and to vary it as a function of the characteristics of the module.

According to a second embodiment of the alternative according to which the membranes extend substantially vertically, said backflow prevention means comprise at least one clack valve mounted in each of said apertures so as to be mobile between at least two positions:
an injection position when the pressure of said gaseous fluid upstream of said clack valve, along the direction of injection, is greater than a preset pressure;
a position of closure of said aperture when the pressure of said gaseous fluid upstream of said clack valve, along the direction of injection, is lower than said preset pressure.

According to a first embodiment of this second approach of the invention, said clack valve or valves comprise a drop valve mounted mobile in translation in said aperture along the longitudinal axis of said aperture.

In this case, said drop valve is preferentially coupled to resilient recall means which tends to bring said drop valve back into said closed position, when the pressure of said gaseous fluid upstream, along the direction of injection, of said clack valve is lower than said preset pressure.

According to a second embodiment of the second approach of the invention, said clack valve or valves comprise at least one resiliently distortable washer mounted on a support extending coaxially to said aperture.

An embodiment of this kind proves to be particularly advantageous in that it combines efficiency, simplicity, reliability and strength over time.

In particular, an arrangement of this kind obviates the need to use a return spring in accordance with the previous embodiment.

According to another characteristic of the invention, said backflow prevention means, and/or said nozzle or nozzles which support them, can be dismantled.

In this way, maintenance interventions are facilitated, when they are necessary. The blowback prevention means can therefore easily and quickly be replaced (or dismantled/reassembled).

According to an advantageous solution, said backflow prevention means are made of at least one material belonging to the following group:
rubber;
silicon;
ethylene-propylene-diene terpolymer;
polyurethane.

Preferentially, said material has a thickness of between about 0.5 mm and about 3 mm.

To advantage, the device comprises means for the distribution of said gaseous fluid that allows said gaseous fluid to be distributed through said backflow prevention means with a throughput of between about 2.10⁻⁵ Nm³/s and about 5.10⁻³ Nm³/s.

According to a preferential embodiment, said membranes are caught in at least one potting, at least at their lower end, said aperture or apertures being provided in said potting.

Preferentially, said membranes are caught in a lower potting and in an upper potting, at their lower and upper end respectively.

According to a preferred solution, said backflow prevention means are provided to bring about a pressure head loss of between about 20 cm and about 60 cm.

Such characteristics relating to the filter cleaning gas can be obtained with relatively traditional means and provide satisfactory filter cleaning.

To advantage, said membranes belong to the group including:
micro-filtration membranes;
ultra-filtration membranes;
nano-filtration membranes.

Other characteristics and advantages of the invention will emerge more clearly from reading the following description of eight embodiments given as illustrative and non-restrictive examples and of the appended drawings among which:

FIGS. 1, 2a, 2b and 3 are each diagrammatic representations of a membrane filtering device according to the prior art;

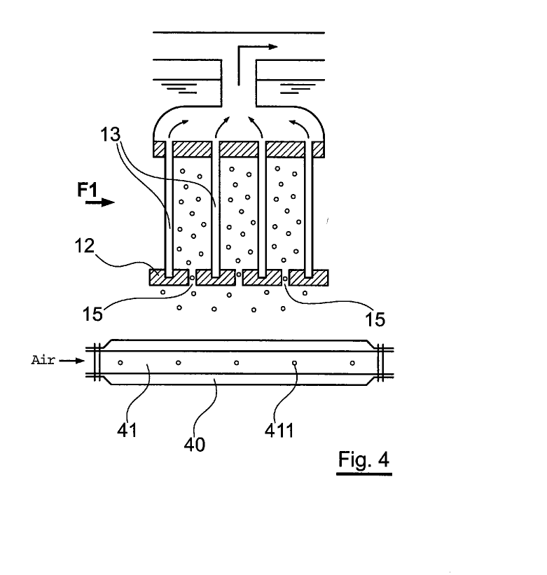

FIG. 4 is a diagrammatic representation of a first embodiment of the invention, according to which the filter cleaning gas is brought in through a perforated pipe,

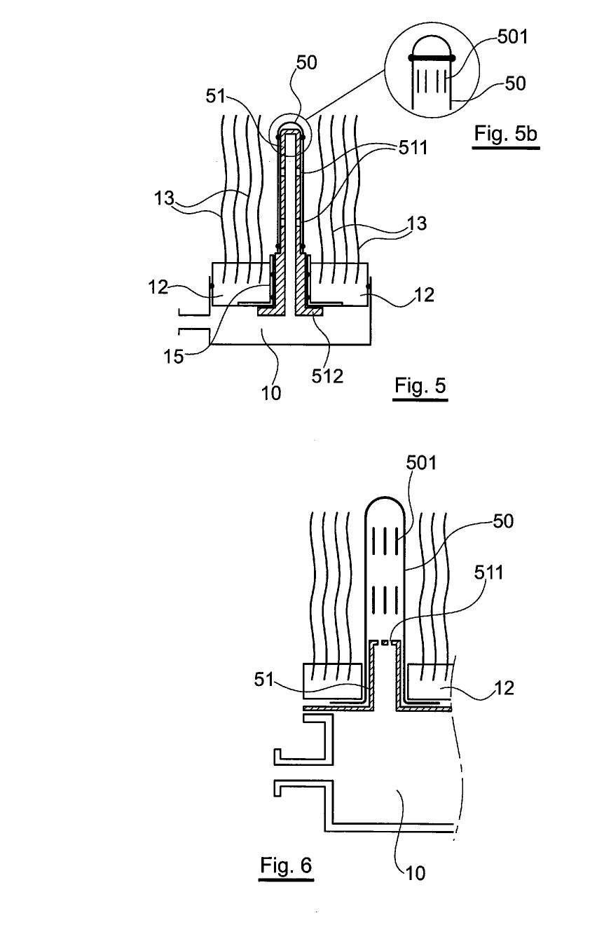

FIG. 5 is a diagrammatic representation of a second-embodiment of the invention, according to which the filter cleaning gas is brought in through a nozzle extending between the membranes;

FIG. 5b is a view of a detail of the device embodiment shown in FIG. 5;

FIG. 6 is a diagrammatic representation of a third embodiment of the invention, according to which the filter cleaning gas is brought in through a nozzle flush with the edges of the injection aperture;

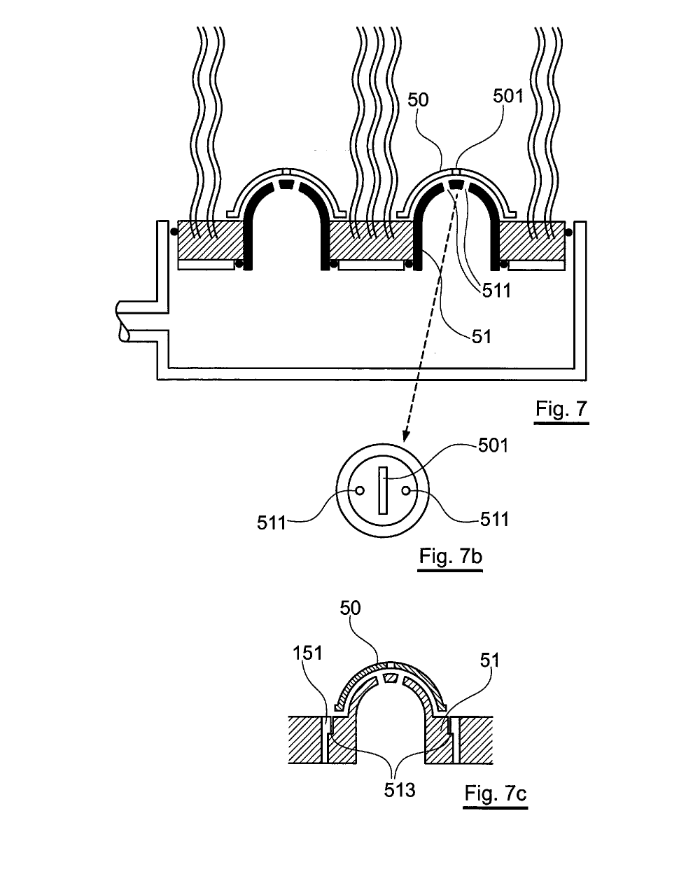

FIG. 7 is a diagrammatic representation of a fourth embodiment of the invention, according to which the filter cleaning gas is brought in through a nozzle having a dome extending between the membranes;

FIG. 7b is a detail view of the device shown in FIG. 7, providing a view from above of the nozzle and its cap;

FIG. 7c is a detail view of an embodiment variant of the device shown in FIG. 7;

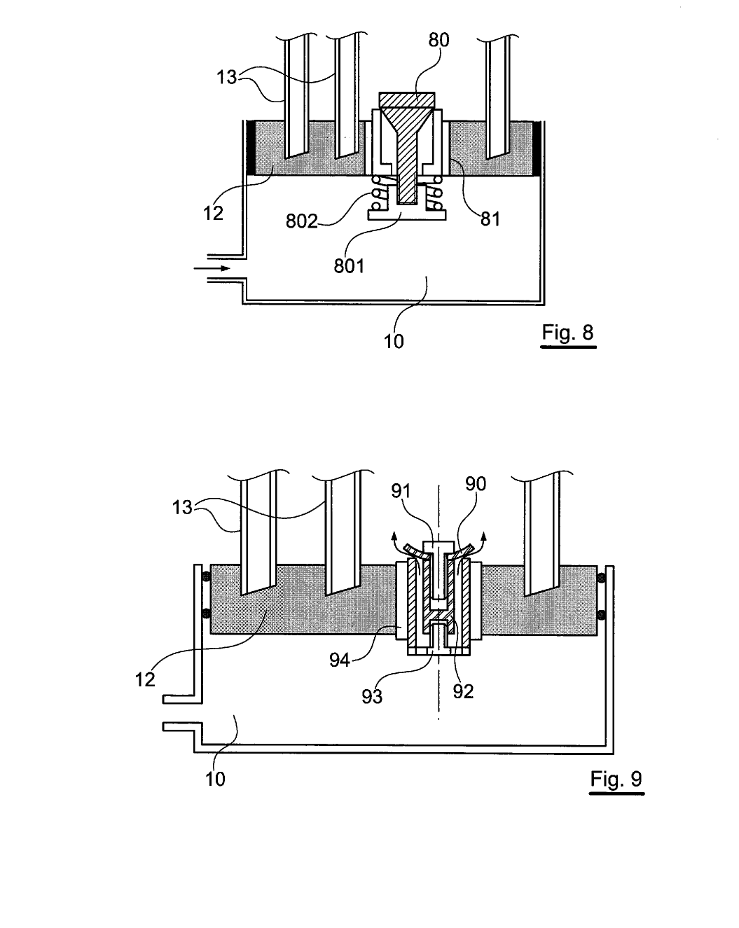

FIG. 8 is a diagrammatic representation of a fifth embodiment of the invention, according to which the filter cleaning gas is brought in through an aperture able to be blocked by a drop valve;

FIG. 9 is a diagrammatic representation of a sixth embodiment of the invention, according to which the filter cleaning gas is brought in through an aperture able to be blocked by a distortable washer.

As already indicated above, the principle of the invention lies in the fact that a membrane filtering device, comprising filter cleaning gas injecting means, is fitted with backflow prevention means provided so that the filterable medium (loaded with sludge or other pollutants) is not able to foul the filter cleaning gas injecting means.

According to a first approach of the invention, these backflow prevention means comprise a resiliently distortable material having passages for the filter cleaning gas, these passages being closed in the absence of gas pressure and open when gas is injected.

A distortable material of this kind, such as rubber, an ethylene-propylene-diene terpolymer (commonly denoted by the term EPDM), silicon or polyurethane (or indeed any other similar resiliently distortable material), having a thickness of between about 0.5 mm and 3 mm, can be used in different ways.

FIG. 4 shows a first embodiment employing such a distortable material forming backflow prevention means.

As it appears, the filtering device is of the type comprising membranes 13 (which may be micro-filtration, ultra-filtration or nano-filtration membranes according to different conceivable embodiments) the lower end of which is caught in a potting 12 with apertures 15 for a filter cleaning gas to pass through.

In this device, (as in all the other devices which will be described below), the filterable medium passes through the membranes 13 along a direction indicated by the arrow Fl.

It is noted that, according to one conceivable alternative, the membranes may be arranged horizontally (in a pattern similar to the one shown in FIG. 2b), the filter cleaning gas being injected using a perforated pipe.

According to the present embodiment, the filter cleaning gas is injected using a perforated pipe 41 (or several thereof) and a distortable material, of the type that has passages as mentioned previously, is added to the perforated pipe 41.

This distortable material is made in the form of a sleeve 40, fitted onto the pipe 41, and anchored to the ends thereof using cable clamps (or by bonding according to another conceivable embodiment).

It is noted that the perforations 411 of the pipe 41 dimensioned so as to generate gas bubbles with a diameter of between 1 and 30 mm, with a pressure head loss in the passages of the sleeve 40 of between 10 and 200 cm.

Furthermore, the flow rate of gas through each distribution orifice is between 2.10⁻⁵ Nm³/s and 5.10⁻³ Nm³/s.

It is also noted that this embodiment may be adapted to a system of injecting or distributing filter cleaning gas, modules, fibres or membrane plates arranged both vertically and horizontally, or in any other position relative to the horizontal.

However, the devices which will be described below relate particularly to fibre or membrane plate modules arranged vertically (or forming an angle of less than 15° with the vertical).

According to the embodiment shown in FIG. 5, the filter cleaning gas is sent into a chamber 10 arranged under the potting 12 of the membranes 13 having to be specific an external diameter of between 0.5 mm and 5 mm (and preferentially between 0.9 mm and 1.8 mm).

The filter cleaning gas is distributed between the membranes 13 using a nozzle 51 extending through an aperture 15 provided in the potting 12.

It is noted that the lower end piece of this nozzle has a base plate 512 intended to be supported under the potting 12, and that this end piece is provided so as to be removed from the corresponding aperture 15, which entails removing the whole nozzle 51 and the backflow prevention cap 50 it carries, for the purpose of any potential maintenance intervention.

The nozzle 51 therefore has a cylindrical portion which extends between the membranes over a length of about 60 mm above the potting area 12, and has a diameter of about 9 mm (which may vary between 5 and 15 mm according to other conceivable embodiments).

Moreover, the nozzle 51 has orifices 511 distributed on its periphery.

As shown, the nozzle 51 carries a cap 50 of length approximately equal to that of the nozzle extending over the potting.

As shown in FIG. 5b which shows an enlargement of the upper end of a cap 50, the latter has at least one set of vertical slits 501 evenly distributed on the periphery of the cap.

According to one embodiment variant shown in FIG. 6, the nozzle 51 is flush with the upper surface of the potting 12 (in other words it does not extend beyond the level of the potting, or only by a few millimetres). Orifices 511 are provided at the upper end of the nozzle 51.

In this case, the cap 50 having slits 501 as described previously extends above the potting over a length of about 60 mm (which may vary between 20 and 500 mm according to other conceivable embodiments).

According to yet another variant shown in FIG. 7, the nozzles 51 may have a dome-shaped upper end in which orifices 511 are provided, this dome being covered by a cap 50.

FIG. 7b is a view from above of a nozzle 50 of the same type as the one shown in FIG. 7, covered by a cap 50.

As is shown, the dome of the nozzle 51 has two orifices 511 between which a slit 501 extends radiantly. It is noted that this slit 501 extends over a length between the diameter of the base of the dome and a third of this diameter.

According to an assembly variant shown in FIG. 7c, the nozzle 51 has a peripheral shoulder 513 intended to engage with a peripheral shoulder provided on a bush 151 placed in each injection aperture of the potting. The diameter of the nozzle and that of the bush are provided so as to allow a slight force fitting of the nozzle into the bush.

Such a fitting allows the nozzle to be removed from the bush, and the shoulders allow the nozzle to be stopped to ensure it stays in position against the pressure of the filter cleaning gas.

It is noted that, in the embodiments employing nozzles which have just been described, provision may be made for calibrated holes or a diaphragm to be installed in each of the nozzles, in order to create a pressure head loss of between 10 cm and 200 cm, and preferentially a head loss of between 20 cm and 60 cm (a pressure loss of this kind allowing a good compromise between the energy cost of the pressure loss and the quality of the gas distribution). This pressure loss can also (and even preferentially) be obtained through the choice of a combination of parameters relating to the thickness of the cap, the resilience of the cap material and the number and length of the slits provided in the cap. FIGS. 8 and 9 each show an embodiment of another approach of the invention, according to which the backflow prevention means are presented in the form of a clack valve mounted in the injection apertures, the clack valves being mobile between a position according to which they allow the gas to pass and a position where the aperture is closed, in the event of the filter cleaning gas injection being stopped.

According to the embodiment shown in FIG. 8, these clack valves include a drop valve 18 mounted mobile in translation inside a bush 81 inserted into an aperture of the potting 12.

This drop valve is anchored to an end piece 801 and a return spring 802 is inserted between the end piece 801 and the lower surface of the potting 12.

In this way, under the effect of the pressure of the injected filter cleaning gas, the drop valve is displaced upwards and creates a passage for the gas through the aperture in the potting.

During this displacement, the spring 802 is compressed. Thus, when the gas injection stops, the drop valve is brought back into the closed position under the action of the return spring 802.

It is noted that the stiffness of the return spring 802 is of course chosen such that it allows the drop valve to open for a preset filter cleaning gas pressure.

According to the embodiment shown in FIG. 9, the clack valves comprise, for each opening provided in the potting, a resilient washer 90.

This washer 90 is held on a support 92 extending coaxially to a bush 94 embedded in the aperture.

The washer 90 is kept in place on the support 92 by a screw 91.

Another screw 93 allows the support stress of the washer on the edges of the aperture to the adjusted and/or the stiffness of the washer to be adjusted.

It will be understood that, under the effect of the pressure of the filter cleaning gas injection, the periphery of the washer lifts and releases a passage for the gas. When the pressure falls, the resilience of the washer means that it returns into support on the edges of the aperture and blocks the passage once again.

1-35. (canceled)

36. A filter system for treating water, comprising:
a. one or more membranes disposed in a membrane chamber and adapted to be immersed in a filterable medium therein;
b. one or more cleaning fluid inlets for permitting a membrane cleaning fluid to be injected into the membrane chamber for cleaning the one or more membranes; and
c. the cleaning fluid inlet being normally closed, but which opens and permits cleaning fluid to flow therethrough in response to the cleaning fluid assuming a predetermined pressure level.

37. The filter system of claim 36 including a pressure source for pressurizing the membrane cleaning fluid.

38. The filter system of claim 36 including a cleaning fluid chamber disposed adjacent the membrane chamber.

39. The filter system of claim 38 wherein the one or more cleaning fluid inlets are disposed between the cleaning fluid chamber and the membrane chamber.

40. The filter system of claim 36 wherein the cleaning fluid inlets include at least one distortable passage that opens in response to the pressure of the cleaning fluid exceeding a predetermined pressure.

41. The filter system of claim 36 wherein the one or more cleaning fluid inlets are disposed beneath the one or more membranes.

42. The filter system of claim 36 wherein the one or more membranes extend generally vertically, and wherein the one or more fluid cleaning inlets are disposed generally below the one or more membranes.

43. The filter system of claim 36 wherein the cleaning fluid inlets include one or more apertures and one or more nozzles extending through the apertures.

44. The filter system of claim 43 including a covering material disposed over at least a portion of the nozzles.

45. The filter system of claim 44 wherein each nozzle includes one or more orifices and wherein the covering material includes one or more openings that open under the influence of pressure of the cleaning fluid.

46. The filter system of claim 44 wherein the covering material forms a cap.

47. The filter system of claim 46 wherein each cap includes a length greater than the associated nozzle.

48. The filter system of claim 36 wherein the one or more cleaning fluid inlets include one or more nozzles that extend into the membrane chamber.

49. The filter system of claim 48 wherein the one or more nozzles include one or more orifices formed therein.

50. The filter system of claim 49 wherein the nozzles include a cylindrical portion having one or more orifices formed therein.

51. The filter system of claim 48 wherein the nozzles include a cylindrical portion having a length between about 20 mm and 200 mm.

52. The filter system of claim 48 including a cap disposed over a portion of each nozzle and wherein the one or more caps include a slit formed therein.

53. The filter system of claim 48 wherein the one or more nozzles include a dome that extend into the membrane chamber and between two or more membranes, the one or more domes having orifices formed therein.

54. The filter system of claim 48 wherein each nozzle includes two orifices and a cap with a slit formed therein wherein the slit lies in the vicinity of the orifices.

55. The filter system of claim 36 wherein the cleaning fluid inlets include a check valve movable between open and closed positions.

56. The filter system of claim 55 wherein the check valve includes a plunger mounted in an aperture and movable between opened and closed positions.

57. The filter system of claim 56 including a spring for biasing the plunger to a closed position.

58. The filter system of claim 55 wherein each check valve comprises at least one resilient distortable washer mounted on a support extending coaxially with respect to an aperture.

59. The filter system of claim 36 wherein the one or more cleaning fluid inlets are constructed of a material taken from the group including rubber, silicon, ethylene-propylene-diene terpolymer and polyurethane.

60. The filter system of claim 59 wherein the material has a thickness of between about 0.5 mm and about 3 mm.

61. The filter system of claim 36 including a pressure source for pressurizing the membrane cleaning fluid and wherein the pressure source is adapted to distribute the cleaning fluid through the cleaning fluid inlets at about 2.10⁻⁵ Nm³/s and about 5.10⁻³ Nm³/s.

62. The filter system of claim 36 wherein the one or more membranes are secured in at least one lower potting and wherein the cleaning fluid inlets include apertures provided in the potting.

63. The filter system of claim 62 wherein the membranes are further secured in an upper potting.

64. The filter system of claim 36 wherein the cleaning fluid inlets provide a pressure head loss of between about 20 cm and about 200 cm.

65. The filter system of claim 36 wherein the one or more membranes are taken from the group including micro-filtration membranes, ultra-filtration membranes, and nano-filtration membranes.

66. The filter system of claim 36 wherein the cleaning fluid is a gaseous cleaning fluid and wherein the cleaning fluid inlets are adapted to permit the gaseous cleaning fluid to be injected through the inlets in response to the pressure of the gaseous cleaning fluid assuming a predetermined pressure.

67. A method of treating water comprising:
a. directing the water into a membrane chamber having one or more immersed membranes disposed therein and filtering the water;
b. from time to time, cleaning the membranes by injecting a cleaning fluid through one or more normally closed cleaning fluid inlets and into the membrane chamber wherein the injected cleaning fluid, through agitation or turbulence, causes the membrane filters to be at least partially cleaned; and
c. the step of injecting the cleaning fluid including pressurizing the cleaning fluid such that the pressure of the cleaning fluid is sufficient to open the normally closed cleaning fluid inlets so as to cause the cleaning fluid to pass through the cleaning fluid inlets into the membrane chamber having the membrane filters therein.

68. The method of claim 67 including injecting a gas through the cleaning fluid inlets.
